(19) United States
(12) Patent Application Publication
(10) Pub. No.: US 2026/0181567 A1
(43) Pub. Date: Jun. 25, 2026

(54) SYNCHRONIZATION RASTER TYPES

(71) Applicant: QUALCOMM Incorporated, San Diego, CA (US)

(72) Inventors: Navid ABEDINI, Basking Ridge, NJ (US); Tao LUO, San Diego, CA (US); Junyi LI, Greentown, PA (US); Xiaoxia ZHANG, San Diego, CA (US); Sony AKKARAKARAN, Poway, CA (US)

(21) Appl. No.: 19/424,751

(22) Filed: Dec. 18, 2025

Related U.S. Application Data
(60) Provisional application No. 63/738,234, filed on Dec. 23, 2024.

(51) Int. Cl. H04W 56/00

(52) U.S. Cl. CPC H04W 56/001

(57) ABSTRACT

Various aspects of the present disclosure generally relate to wireless communication. In some aspects, a user equipment (UE) may prioritize, based at least in part on multiple synchronization raster types, two or more synchronization rasters according to their respective synchronization raster types included in the multiple synchronization raster types to select a highest priority synchronization raster in the two or more synchronization rasters. The UE may search for a synchronization signal based at least in part on the highest priority synchronization raster. Numerous other aspects are described.

### PRIORITY INFORMATION

The present application for patent claims priority under 35 U.S.C. § 119 to U.S. Provisional Patent Application No. 63/738,234, filed on Dec. 23, 2024, and entitled “SYNCHRONIZATION RASTER TYPES,” which is assigned to the assignee hereof and hereby expressly incorporated by reference herein.

### FIELD OF THE DISCLOSURE

Aspects of the present disclosure generally relate to wireless communication and specifically relate to techniques, apparatuses, and methods associated with synchronization raster types.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A synchronization raster may specify a frequency grid that is used by a user equipment (UE) to search for a signal or information that enables the UE to identify a network node and/or gain initial access to a network provided by the network node. As one example, the signal may be a synchronization signal, such as a synchronization signal block. In some cases, a communication standard may specify a synchronization raster and/or parameters of the synchronization raster that enable a UE to locate a synchronization signal and/or perform initial access to the network.

### SUMMARY

Some aspects described herein relate to a method of wireless communication performed by a user equipment (UE). The method may include prioritizing, based at least in part on multiple synchronization raster types, two or more synchronization rasters according to their respective synchronization raster types, included in the multiple synchronization raster types, to select a highest priority synchronization raster in the two or more synchronization rasters. The method may include searching for a synchronization signal based at least in part on the highest priority synchronization raster.

Some aspects described herein relate to a method of wireless communication performed by a UE. The method may include receiving an indication of synchronization raster assistance information that is associated with a synchronization signal associated with access to a network, the indication of the synchronization raster assistance information specifying a synchronization raster property of the synchronization raster assistance information. The method may include receiving the synchronization raster assistance information. The method may include searching for the synchronization signal using the synchronization raster assistance information.

Some aspects described herein relate to a method of wireless communication performed by a network node. The method may include transmitting an indication of a supported synchronization raster type. The method may include transmitting a synchronization signal based at least in part on a synchronization raster that is the supported synchronization raster type.

Some aspects described herein relate to a method of wireless communication performed by a network node. The method may include transmitting, in first signaling, an indication of synchronization raster assistance information that is associated with a synchronization signal associated with access to a network, the indication of the synchronization raster assistance information specifying a synchronization raster property of the synchronization raster assistance information. The method may include transmitting, in second signaling, the synchronization raster assistance information.

Some aspects described herein relate to an apparatus for wireless communication at a UE. The apparatus may include one or more code-storing memories and one or more processors coupled to the one or more code-storing memories. The one or more processors may be configured to prioritize, based at least in part on multiple synchronization raster types, two or more synchronization rasters according to their respective synchronization raster types included in the multiple synchronization raster types to select a highest priority synchronization raster in the two or more synchronization rasters. The one or more processors may be configured to search for a synchronization signal based at least in part on the highest priority synchronization raster.

Some aspects described herein relate to an apparatus for wireless communication at a UE. The apparatus may include one or more code-storing memories and one or more processors coupled to the one or more code-storing memories. The one or more processors may be configured to receive an indication of synchronization raster assistance information that is associated with a synchronization signal associated with access to a network, the indication of the synchronization raster assistance information specifying a synchronization raster property of the synchronization raster assistance information. The one or more processors may be configured to receive the synchronization raster assistance information. The one or more processors may be configured to search for the synchronization signal using the synchronization raster assistance information.

Some aspects described herein relate to an apparatus for wireless communication at a network node. The apparatus may include one or more code-storing memories and one or more processors coupled to the one or more code-storing memories. The one or more processors may be configured to transmit an indication of a supported synchronization raster type. The one or more processors may be configured to transmit a synchronization signal based at least in part on a synchronization raster that is the supported synchronization raster type.

Some aspects described herein relate to an apparatus for wireless communication at a network node. The apparatus may include one or more code-storing memories and one or more processors coupled to the one or more code-storing memories. The one or more processors may be configured to transmit, in first signaling, an indication of synchronization raster assistance information that is associated with a synchronization signal associated with access to a network, the indication of the synchronization raster assistance information specifying a synchronization raster property of the synchronization raster assistance information. The one or more processors may be configured to transmit, in second signaling, the synchronization raster assistance information.

Some aspects described herein relate to a non-transitory computer-readable medium that stores a set of instructions for wireless communication by a UE. The set of instructions, when executed by one or more processors of the UE, may cause the UE to prioritize, based at least in part on multiple synchronization raster types, two or more synchronization rasters according to their respective synchronization raster types included in the multiple synchronization raster types to select a highest priority synchronization raster in the two or more synchronization rasters. The set of instructions, when executed by one or more processors of the UE, may cause the UE to search for a synchronization signal based at least in part on the highest priority synchronization raster.

Some aspects described herein relate to a non-transitory computer-readable medium that stores a set of instructions for wireless communication by a UE. The set of instructions, when executed by one or more processors of the UE, may cause the UE to receive an indication of synchronization raster assistance information that is associated with a synchronization signal associated with access to a network, the indication of the synchronization raster assistance information specifying a synchronization raster property of the synchronization raster assistance information. The set of instructions, when executed by one or more processors of the UE, may cause the UE to receive the synchronization raster assistance information. The set of instructions, when executed by one or more processors of the UE, may cause the UE to search for the synchronization signal using the synchronization raster assistance information.

Some aspects described herein relate to a non-transitory computer-readable medium that stores a set of instructions for wireless communication by a network node. The set of instructions, when executed by one or more processors of the network node, may cause the network node to transmit an indication of a supported synchronization raster type. The set of instructions, when executed by one or more processors of the network node, may cause the network node to transmit a synchronization signal based at least in part on a synchronization raster that is the supported synchronization raster type.

Some aspects described herein relate to a non-transitory computer-readable medium that stores a set of instructions for wireless communication by a network node. The set of instructions, when executed by one or more processors of the network node, may cause the network node to transmit, in first signaling, an indication of synchronization raster assistance information that is associated with a synchronization signal associated with access to a network, the indication of the synchronization raster assistance information specifying a synchronization raster property of the synchronization raster assistance information. The set of instructions, when executed by one or more processors of the network node, may cause the network node to transmit, in second signaling, the synchronization raster assistance information.

Some aspects described herein relate to an apparatus for wireless communication. The apparatus may include means for prioritizing, based at least in part on multiple synchronization raster types, two or more synchronization rasters according to their respective synchronization raster types included in the multiple synchronization raster types to select a highest priority synchronization raster in the two or more synchronization rasters. The apparatus may include means for searching for a synchronization signal based at least in part on the highest priority synchronization raster.

Some aspects described herein relate to an apparatus for wireless communication. The apparatus may include means for receiving an indication of synchronization raster assistance information that is associated with a synchronization signal associated with access to a network, the indication of the synchronization raster assistance information specifying a synchronization raster property of the synchronization raster assistance information. The apparatus may include means for receiving the synchronization raster assistance information. The apparatus may include means for searching for the synchronization signal using the synchronization raster assistance information.

Some aspects described herein relate to an apparatus for wireless communication. The apparatus may include means for transmitting an indication of a supported synchronization raster type. The apparatus may include means for transmitting a synchronization signal based at least in part on a synchronization raster that is the supported synchronization raster type.

Some aspects described herein relate to an apparatus for wireless communication. The apparatus may include means for transmitting, in first signaling, an indication of synchronization raster assistance information that is associated with a synchronization signal associated with access to a network, the indication of the synchronization raster assistance information specifying a synchronization raster property of the synchronization raster assistance information. The apparatus may include means for transmitting, in second signaling, the synchronization raster assistance information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a table that is associated with synchronization rasters for respective operating bands, in accordance with the present disclosure.

FIG. 4 is a diagram illustrating an example of a wireless communication process between a network node and a user equipment (UE), in accordance with the present disclosure.

FIG. 5 is a diagram illustrating an example of a wireless communication process between a first network node, a second network node, and a UE, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A synchronization raster may specify a frequency grid that is used by a user equipment (UE) to search for a signal or information that enables the UE to identify a network node and/or gain initial access to a network provided by the network node. As one example, the signal may be a synchronization signal, such as a synchronization signal block (SSB). A synchronization raster may be based at least in part on a frequency range that is associated with an operating band of a radio access technology (RAT) that is supported by the network node. In some cases, a communication standard may specify a synchronization raster and/or parameters of the synchronization raster that enable a UE to locate a synchronization signal and/or perform initial access to the network. Example parameters include subcarrier spacing, a global synchronization channel number (GSCN) range, and/or an SSB pattern. Alternatively, or additionally, a UE may obtain one or more parameters of a synchronization raster from a network node. The ability for a network node to indicate synchronization raster parameters may enable the network node to customize the synchronization raster to an initial access implementation at the network node.

During an initial cell selection, a UE may blindly search over multiple synchronization rasters. Power consumption at the UE may proportionally increase as a quantity of scans performed by the UE increases and/or a quantity of synchronization rasters searched by a UE increases, resulting in a reduced operating life of the UE. Alternatively, or additionally, an increased quantity of scans and/or increased quantity of synchronization rasters used by the UE may increase a latency in obtaining access to a network.

Various aspects relate generally to synchronization raster types. Some aspects more specifically relate to a network node using multiple synchronization raster types to reduce a synchronization raster search count at a UE. In some aspects, a UE may prioritize, based at least in part on multiple synchronization raster types, two or more synchronization rasters according to their respective synchronization raster types included in the multiple synchronization raster types to select a highest priority synchronization raster in the two or more synchronization rasters. Based at least in part on selecting the highest priority synchronization raster, the UE may search for a synchronization signal.

Alternatively, or additionally, a UE may receive an indication of synchronization raster assistance information that is associated with a synchronization signal associated with access to a network. In some aspects, the indication of the synchronization raster assistance information specifies a synchronization raster property of the synchronization raster assistance information. Alternatively, or additionally, the synchronization raster assistance information may be associated with a synchronization raster type. The UE may receive the synchronization raster assistance information and search for the synchronization signal using the synchronization raster assistance information.

Particular aspects of the subject matter described in this disclosure can be implemented to realize one or more of the following potential advantages. In some examples, by using synchronization raster types and/or synchronization raster assistance information, the described techniques can be used to enable a UE to reduce a quantity of scans performed by the UE and/or reduce a quantity of synchronization rasters used by the UE to locate a synchronization signal and, consequently, reduce power consumption by the UE. To illustrate, different synchronization raster types may be associated with different scaling factors and/or different step sizes for scanning a range of GSCNs, and a UE may prioritize synchronization rasters that have a larger scaling factor and/or a larger step size to reduce the quantity of scans performed by the UE and, consequently, reduce power consumption at the UE. Alternatively, or additionally, the UE may reduce a latency that is associated with gaining access to a network. For instance, the UE may prioritize synchronization raster types that are associated with providing assistance information that enables the UE to locate a synchronization signal more quickly, resulting in reduced power consumption by the UE and/or reduced latency in initial access to a network.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

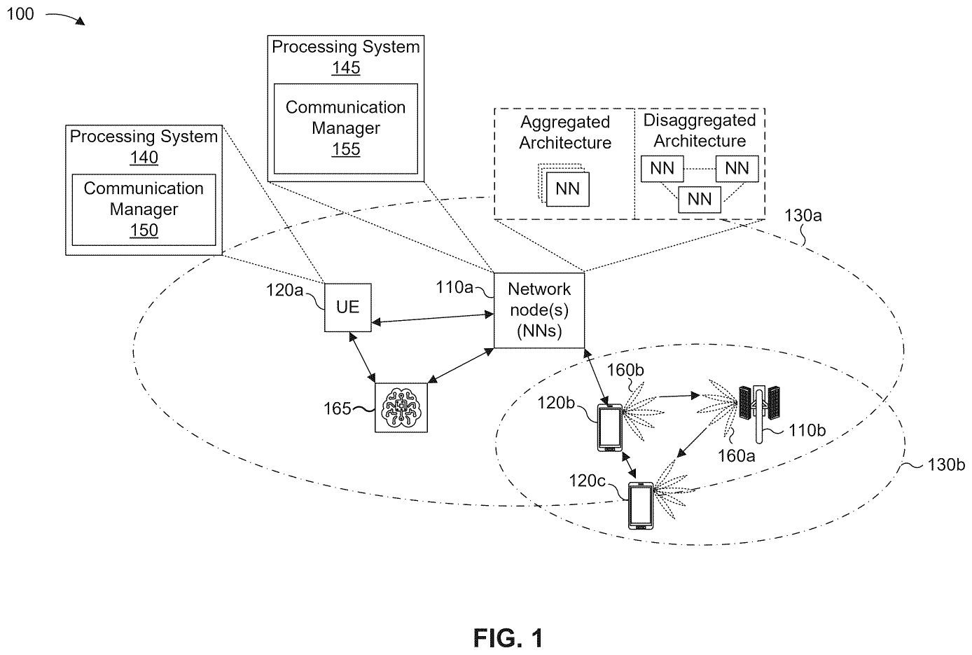

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

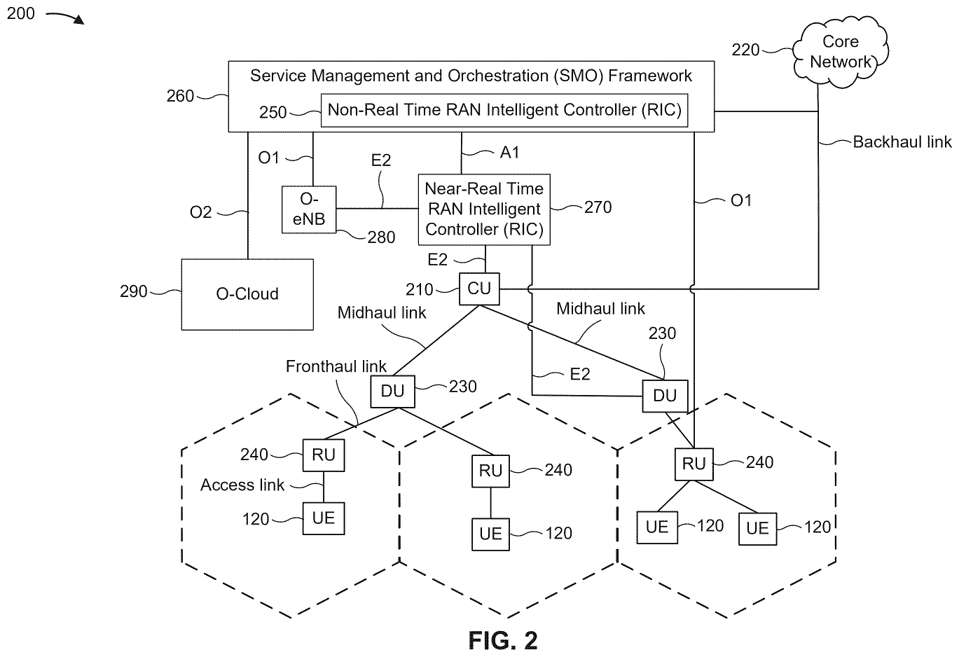

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (JAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, abase station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., a UE 120) may include a communication manager 150. As described in more detail elsewhere herein, the communication manager 150 may prioritize, based at least in part on multiple synchronization raster types, two or more synchronization rasters, according to their respective synchronization raster types included in the multiple synchronization raster types, to select a highest priority synchronization raster in the two or more synchronization rasters; and search for a synchronization signal based at least in part on the highest priority synchronization raster.

Alternatively, or additionally, the communication manager 150 may receive an indication of synchronization raster assistance information that is associated with a synchronization signal associated with access to a network, the indication of the synchronization raster assistance information specifying a synchronization raster property of the synchronization raster assistance information; receive the synchronization raster assistance information; and search for the synchronization signal using the synchronization raster assistance information. Additionally, or alternatively, the communication manager 150 may perform one or more other operations described herein.

In some aspects, a network node (e.g., a network node 110) may include a communication manager 155. As described in more detail elsewhere herein, the communication manager 155 may transmit an indication of a supported synchronization raster type; and transmit a synchronization signal based at least in part on a synchronization raster that is the supported synchronization raster type.

Alternatively, or additionally, the communication manager 155 may transmit, in first signaling, an indication of synchronization raster assistance information that is associated with a synchronization signal associated with access to a network, the indication of the synchronization raster assistance information specifying a synchronization raster property of the synchronization raster assistance information; and transmit, in second signaling, the synchronization raster assistance information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

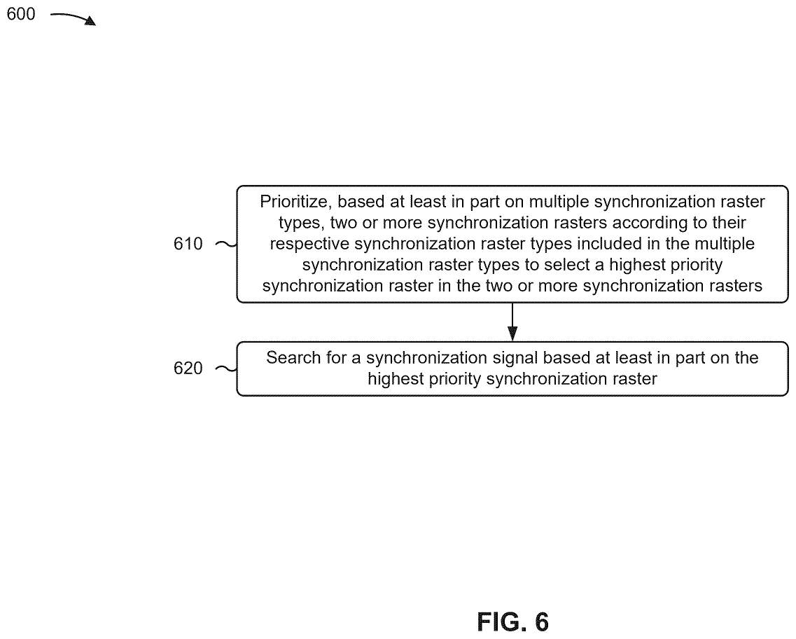

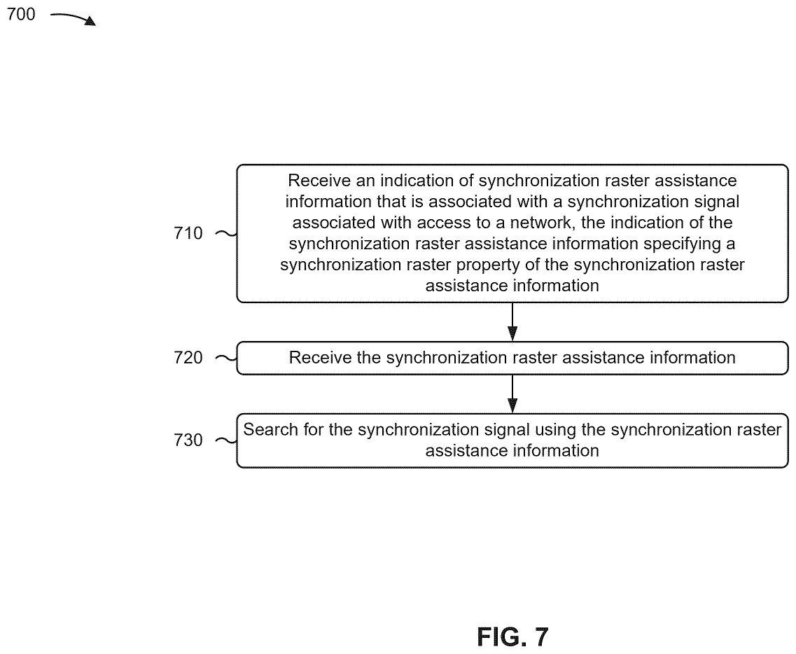

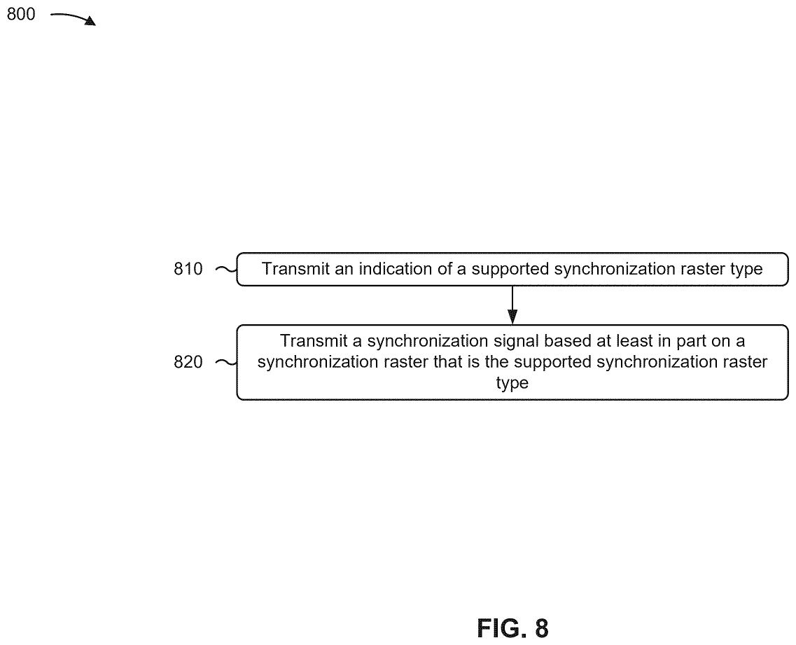

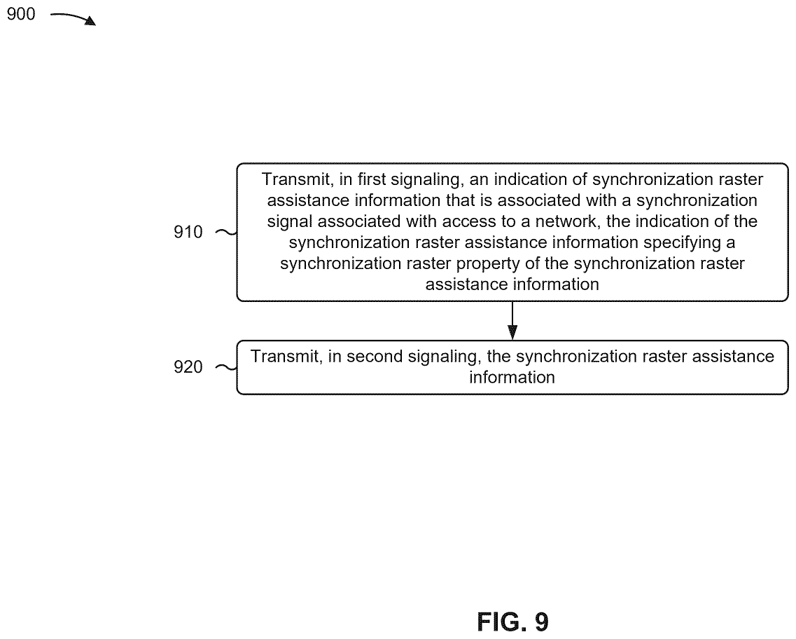

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with synchronization raster types, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a UE (e.g., a UE 120) includes means for prioritizing, based at least in part on multiple synchronization raster types, two or more synchronization rasters according to their respective synchronization raster types included in the multiple synchronization raster types to select a highest priority synchronization raster in the two or more synchronization rasters; and/or means for searching for a synchronization signal based at least in part on the highest priority synchronization raster.

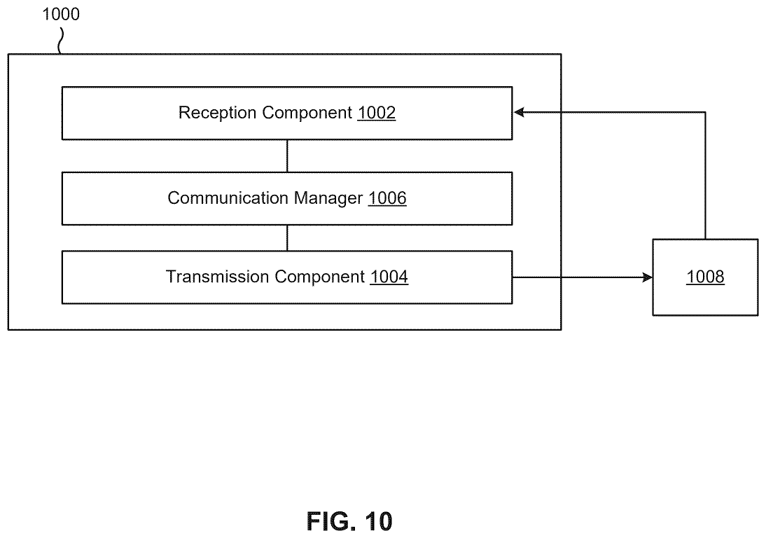

Alternatively, or additionally, the UE includes means for receiving an indication of synchronization raster assistance information that is associated with a synchronization signal associated with access to a network, the indication of the synchronization raster assistance information specifying a synchronization raster property of the synchronization raster assistance information; means for receiving the synchronization raster assistance information; and/or means for searching for the synchronization signal using the synchronization raster assistance information. The means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

In some aspects, a network node (e.g., a network node 110) includes means for transmitting an indication of a supported synchronization raster type; and/or means for transmitting a synchronization signal based at least in part on a synchronization raster that is the supported synchronization raster type.

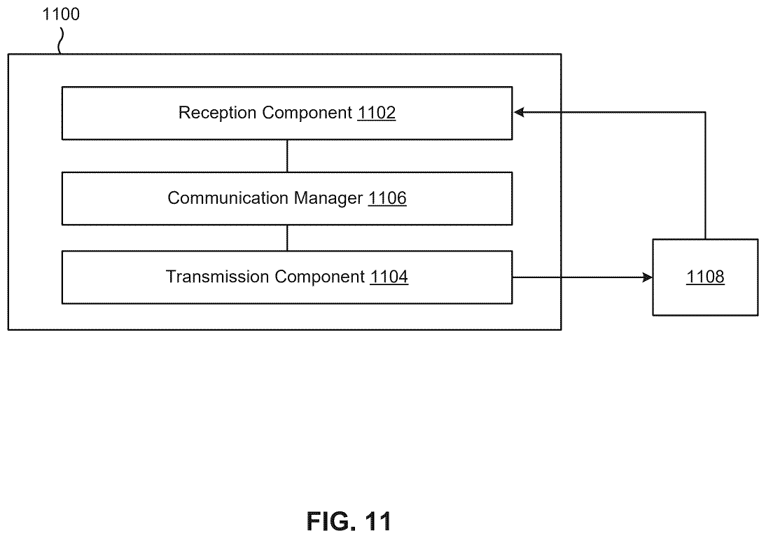

Alternatively, or additionally, the network node includes means for transmitting, in first signaling, an indication of synchronization raster assistance information that is associated with a synchronization signal associated with access to a network, the indication of the synchronization raster assistance information specifying a synchronization raster property of the synchronization raster assistance information; and/or means for transmitting, in second signaling, the synchronization raster assistance information. The means for the network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1004 depicted and described in connection with FIG. 11), among other examples.

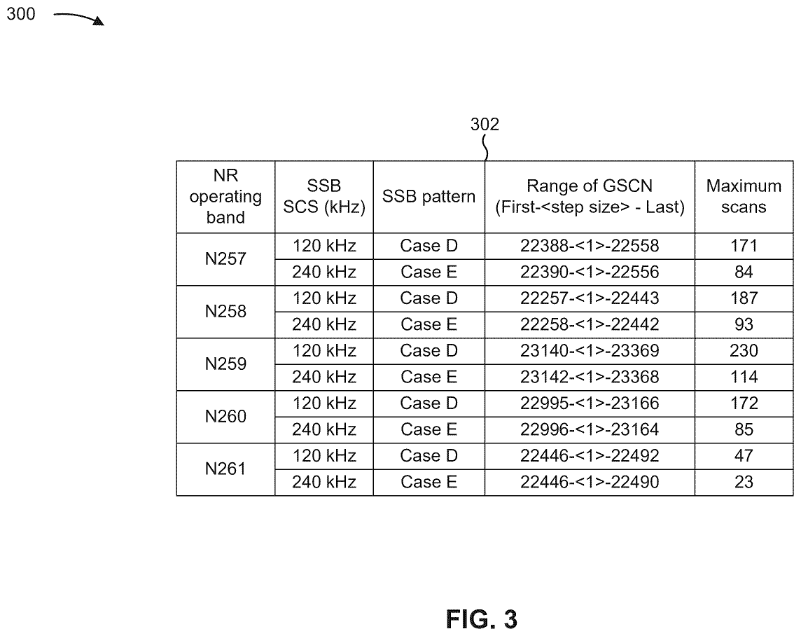

FIG. 3 is a diagram illustrating an example 300 of a table 302 that is associated with synchronization rasters for respective operating bands, in accordance with the present disclosure.

A synchronization raster may specify a frequency grid that is used by a UE (e.g., a UE 120) to search for a signal or information that enables the UE to identify a network node and/or gain initial access to a network provided by the network node. As one example, the signal may be a synchronization signal, such as an SSB that includes a PSS, an SSS, and/or a PBCH. A synchronization raster may be based at least in part on a frequency range that is associated with an operating band of a RAT that is supported by the network node. For instance, an NR synchronization raster may be associated with an NR operating band. In some cases, a communication standard may specify a synchronization raster and/or parameters of the synchronization raster that enable a UE to locate a synchronization signal and/or perform initial access to the network. Example parameters include subcarrier spacing, a global synchronization channel number (GSCN) range, and/or an SSB pattern. Alternatively, or additionally, a UE may obtain one or more parameters of a synchronization raster from a network node. To illustrate, a network node may transmit a synchronization raster parameter in a system information block (SIB). The ability for a network node to indicate synchronization raster parameters may enable the network node to customize the synchronization raster to an initial access implementation at the network node.

The table 302 specifies a variety of configurations that are based at least in part on an NR operating band (shown as N257, N258, N259, N260, and N261), SSB SCS, an SSB pattern, and a range of GSCNs. Each row of the table 302 is associated with a respective NR operating band and indicates, for the respective NR operating band, a frequency range to use in a search for a signal (e.g., a synchronization signal). The associated SSB SCS configuration in each row indicates a subcarrier spacing adjustment for the UE to use in detecting an SSB (e.g., as the signal), while the respective SSB pattern in each row indicates a time-frequency location (e.g., when and where) that is associated with the SSB. To illustrate, an SSB pattern may be based at least in part on beamforming, time-domain locations, and/or a number of SSBs per carrier. A “Case D” SSB pattern that is associated with 120 kHz SCS may support more beams relative to a “Case E” SSB pattern that is associated with 240 kHz SCS, resulting in a tradeoff between coverage and efficiency. As shown by FIG. 3, each row of the table 302 is associated with a respective configuration for the range of GSCNs that specifies a first GSCN to search, a last GSCN to search, and a step size for scanning a range between the first GSCN and the last GSCN. In some cases, each row may be referred to as a synchronization raster. For instance, table 302 includes 10 rows with distinct configurations, resulting in 10 synchronization rasters.

During an initial cell selection, a UE may blindly search over multiple synchronization rasters. To illustrate, table 302 includes a column that indicates a maximum number of scans (shown as “Maximum scans”) that a UE may perform using the associated synchronization raster to locate a synchronization signal. Power consumption at the UE may proportionally increase as a quantity of scans performed by the UE increases and/or a quantity of synchronization rasters searched by a UE increases, resulting in a reduced operating life of the UE. Alternatively, or additionally, an increased quantity of scans and/or increased quantity of synchronization rasters used by the UE may increase a latency in obtaining access to a network.

Various aspects relate generally to synchronization raster types. Some aspects more specifically relate to a network node using multiple synchronization raster types to reduce a synchronization raster search count at a UE. In some aspects, a UE may prioritize, based at least in part on multiple synchronization raster types, two or more synchronization rasters according to their respective synchronization raster types included in the multiple synchronization raster types to select a highest priority synchronization raster in the two or more synchronization rasters. Based at least in part on selecting the highest priority synchronization raster, the UE may search for a synchronization signal.

Alternatively, or additionally, a UE may receive an indication of synchronization raster assistance information that is associated with a synchronization signal associated with access to a network. In some aspects, the indication of the synchronization raster assistance information specifies a synchronization raster property of the synchronization raster assistance information. Alternatively, or additionally, the synchronization raster assistance information may be associated with a synchronization raster type. The UE may receive the synchronization raster assistance information and search for the synchronization signal using the synchronization raster assistance information.

Particular aspects of the subject matter described in this disclosure can be implemented to realize one or more of the following potential advantages. In some examples, by using synchronization raster types and/or synchronization raster assistance information, the described techniques can be used to enable a UE to reduce a quantity of scans performed by the UE and/or reduce a quantity of synchronization rasters used by the UE to locate a synchronization signal and, consequently, reduce power consumption by the UE. To illustrate, different synchronization raster types may be associated with different scaling factors and/or different step sizes for scanning a range of GSCNs, and a UE may prioritize synchronization rasters that have a larger scaling factor and/or a larger step size (e.g., higher than synchronization rasters that have a smaller scaling factor and/or a smaller step size) to reduce the quantity of scans performed by the UE and, consequently, reduce power consumption at the UE. Alternatively, or additionally, the UE may reduce a latency that is associated with gaining access to a network. For instance, the UE may prioritize synchronization raster types that are associated with providing assistance information that enables the UE to locate a synchronization signal more quickly, resulting in reduced power consumption by the UE and/or reduced latency in initial access to a network.

As indicated above, FIG. 3 is provided as an example. Other examples may differ from what is described with respect to FIG. 3.

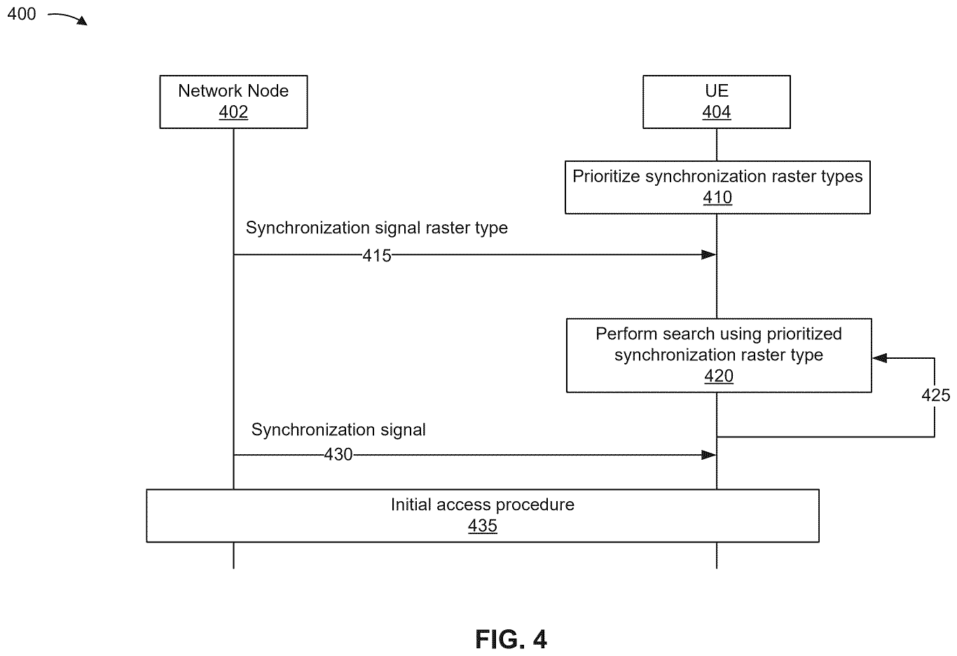

FIG. 4 is a diagram illustrating an example 400 of a wireless communication process between a network node 402 (e.g., a network node 110) and a UE 404 (e.g., a UE 120), in accordance with the present disclosure. Various aspects described with regard to the example 400 may be combined with various aspects described with regard to the example 500 described below.

As described with regard to FIG. 3, a synchronization raster may specify a frequency grid that is used by a UE (e.g., a UE 120) to search for a signal or information that enables the UE to identify a network node and/or gain initial access to a network provided by the network node. That is, the synchronization raster may be a list of valid frequency locations (e.g., a frequency grid) that may be searched by a UE to locate one or more synchronization signals, such as a PSS and/or an SSS that carry information that enable the UE to identify a network node and/or initiate an initial access procedure. “Synchronization raster type” denotes a category of a synchronization raster, which may include a configuration of a synchronization raster (e.g., one or more parameters that are used to indicate a frequency grid) and/or may characterize information that may be located using the synchronization raster. As one non-limiting example, a primary synchronization raster type may be a first type of synchronization raster that specifies a first frequency grid for locating primary information, such as a frequency grid that indicates valid frequency locations for one or more synchronization signals (e.g., a PSS and/or an SSS) that carry the primary information (e.g., information that identifies a network node and/or information that may be used to initiate an initial access procedure). Alternatively, or additionally, a primary synchronization raster type may have and/or use a first configuration to specify the first frequency grid, such as a first step size, a first GSCN range, and/or a first scaling factor (e.g., for the step size). Accordingly, a UE may locate a PSS and/or an SSS using a frequency grid that is specified by a primary synchronization raster (e.g., a synchronization raster that is categorized as a primary synchronization raster type), and the first frequency grid may be based at least in part on the first configuration of a primary synchronization raster type.

As a second non-limiting example, a secondary synchronization raster type may be a second type of synchronization raster that specifies a second frequency grid for locating a synchronization signal and/or another signal that carries secondary information, such as synchronization raster assistance information as described below. Alternatively, or additionally, the secondary synchronization raster type may specify a frequency grid to search using a second configuration that may, or may not, differ from the first configuration of the primary synchronization raster type. To illustrate, a synchronization raster that is categorized as a secondary synchronization raster type may specify a second frequency grid using a second step size, a second GSCN range, and/or a second scaling factor that may, or may not, be different from any combination of the first frequency grid, the first step size, the first GSCN range, and/or the first scaling factor. Accordingly, in specifying synchronization raster types, the communication standard may specify a respective configuration each synchronization raster type and/or may specify a type of information that may be located using a synchronization raster that is categorized as the synchronization raster type.

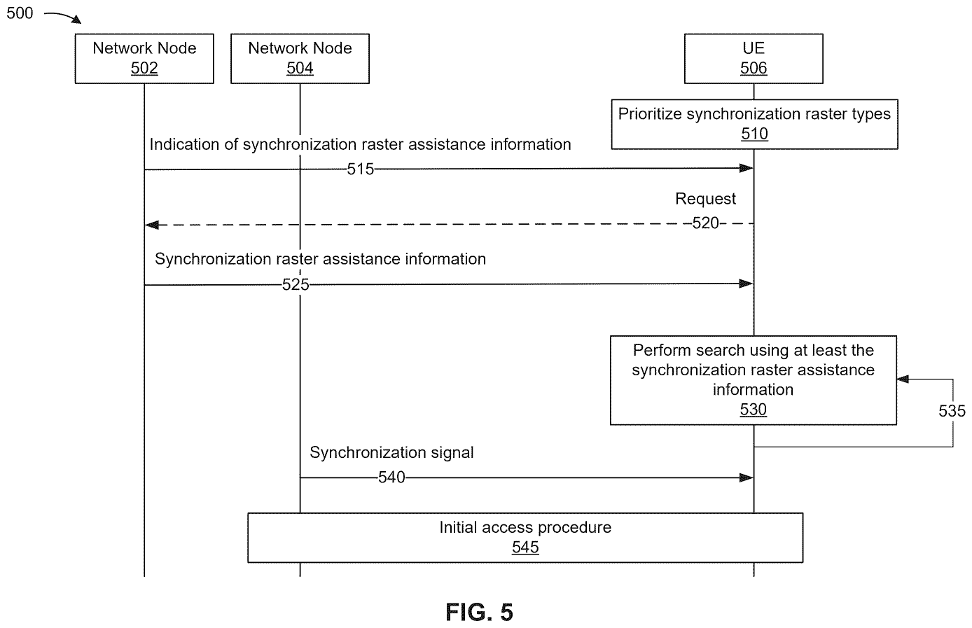

Synchronization raster assistance information carried by a synchronization signal and/or an additional signal may indicate one or more parameters that enable the UE 404 to perform a second search to locate a second synchronization signal, a second signal, and/or second information (e.g., relative to a first search performed by the UE 404 to locate a first synchronization signal and/or a first signal that carries first information. To illustrate, the first information may be the synchronization raster assistance information that provides parameter(s) that enable the UE 404 to locate, as the second information, primary information (e.g., information that identifies a network node and/or information that may be used to initiate an initial access procedure). Examples of synchronization raster assistance information are further described below with regard to FIG. 5.

In specifying a synchronization raster type, a communication standard may specify a respective list of synchronization rasters for each synchronization raster type, such as in a similar manner as the table 302 described with regard to FIG. 3. For instance, a communication standard may specify a primary synchronization raster type and/or a secondary raster type based at least in part on specifying a respective table for each synchronization raster type (e.g., similar to the table 302 described with regard to FIG. 3) and specifying a respective configuration for each entry (e.g., each synchronization raster) in table. Each respective configuration may indicate a respective frequency grid, and examples of parameters that may be indicated by the respective configuration include a step size, a scaling factor, a GSCN range, and/or an SSB pattern. In some aspects, a first configuration for a first synchronization raster type may include a parameter type (e.g., an SSB pattern) that is excluded from a second configuration for a second synchronization raster type.

Alternatively, or additionally, the communication standard may specify a synchronization raster type that is linked to a feature, category, and/or cell type in a wireless network (e.g., a feature-specific synchronization raster type, a category-specific synchronization raster type, and/or a cell-type-specific synchronization raster type). That is, a feature-specific synchronization raster type, a category-specific synchronization raster type, and/or a cell-type-specific synchronization raster type may indicate a frequency grid of valid frequency locations for locating signaling and/or information related to the associated feature, category, and/or cell type. To illustrate, the communication standard may specify a synchronization raster type that is associated with a non-terrestrial network and/or a synchronization raster type that is associated with a terrestrial network. A synchronization raster that is categorized as a non-terrestrial network synchronization raster type may indicate a frequency grid for locating non-terrestrial network primary information (e.g., information that identifies a non-terrestrial network node and/or information that may be used to initiate an initial access procedure with the non-terrestrial network node) and/or non-terrestrial network synchronization raster assistance information (e.g., information that directs the UE to the primary information of the non-terrestrial network). In a similar manner, a synchronization raster that is categorized as a terrestrial network synchronization raster type may indicate a frequency grid for locating terrestrial network primary information and/or terrestrial network synchronization raster assistance information. Other examples of synchronization raster types that may be specified by a communication standard may include a synchronization raster type for a macro cell, a synchronization raster type for a small cell, a synchronization raster type for a network energy saving (NES) mode, a synchronization raster type for a normal (e.g., a non-NES) mode, a synchronization raster type for a mobile communication system (e.g., 5G or 6G), a synchronization raster type for a stationary network node, and/or a synchronization raster type for a mobile network node. In a similar manner as described above, a communication standard may specify respective configurations for each feature-specific synchronization raster type, each category-specific synchronization raster type, and/or each cell-type-specific synchronization raster type.

By specifying different synchronization raster types, a communication standard may enable a UE to prioritize synchronization raster types that have a larger scaling factor and/or a larger step size (e.g., higher than synchronization rasters that have a smaller scaling factor and/or a smaller step size) to reduce the quantity of scans performed by the UE and, consequently, reduce power consumption at the UE. For instance, based at least in part on a stored power level satisfying a low power threshold, the UE may prioritize a synchronization raster type that has a step size greater than one in order to reduce a quantity of scans performed by the UE 404 and reduce power consumption. Alternatively, or additionally, the UE may reduce a latency that is associated with gaining access to a network. As shown by reference number 410, a UE 404 may prioritize one or more synchronization raster types. For instance, based at least in part on a communication standard specifying multiple synchronization raster types, the UE 404 may prioritize two or more synchronization raster types to select a highest priority synchronization raster type and, consequently, a highest priority synchronization raster that is categorized as the highest priority synchronization raster type. For instance, the UE 404 may prioritize the synchronization raster types based at least in part on the respective configurations of each synchronization raster type and/or an operating condition at the UE 404 (e.g., a power level and/or a data traffic pattern). Examples of synchronization raster types specified by a communication standard may include a primary synchronization raster type, a secondary synchronization raster type, a non-terrestrial network synchronization raster type, a terrestrial network synchronization raster type, a macro cell raster type, a small cell synchronization raster type, an NES mode synchronization raster type, a non-NES mode synchronization raster type, a mobile communication system synchronization raster type, a stationary synchronization raster type, and/or a mobile network node synchronization raster type. In specifying the synchronization raster type(s), the communication standard may specify a respective configuration for each synchronization raster type, where the configuration may include one or more parameters (e.g., a step size, a GSCN range, an SSB pattern, and/or a scaling factor) that may be used to indicate valid frequency locations to search for signal (e.g., a synchronization signal and/or an additional signal) that carries particular information, such as primary information and/or synchronization raster assistance information. In specifying a synchronization raster type, a communication standard may specify a respective list of synchronization rasters for each synchronization raster type, such as the list of synchronization rasters described with regard to the table 302 of FIG. 3.

As shown by reference number 415, a network node 402 may transmit, and the UE 404 may receive, an indication of a synchronization raster type. For instance, the network node 402 may transmit a broadcast message that indicates and/or advertises a synchronization raster type that is supported and/or used by the network node 402. In supporting and/or using a synchronization raster type, the network node 402 may transmit a signal (e.g., a synchronization signal and/or another signal) that carries information (e.g., primary information, synchronization raster assistance information, feature-specific information, category-specific information, and/or cell-type specific information) that is linked to the synchronization raster type.

Alternatively, or additionally, the network node 402 may transmit, broadcast, and/or advertise one or more synchronization raster properties that indicate one or more characteristics of a synchronization raster type that is transmitted by the network node 402. Example synchronization raster properties that are indicated by the network node 402 may include any combination of a presence property (e.g., that indicates a presence or a lack of presence) of a particular synchronization raster type, a time duration property for the synchronization raster type, and/or a validity area property. In some aspects, a synchronization raster property transmitted by the network node 402 may be band-specific (e.g., a band-specific synchronization raster property). That is, a presence property transmitted by the network node 402 may be band-specific such that the presence property applies to a first band and/or does not apply to a second band.

To illustrate, the network node 402 may indicate a presence property (e.g., a presence synchronization raster type property) that is associated with a primary synchronization raster type, and the presence property may indicate that the primary synchronization raster type is present (e.g., used by the network node) or is not present (e.g., is not used by the network node). In indicating that the primary synchronization raster type is present via the presence property, the network node 402 may indicate that the network node 402 transmits a signal (e.g., an SSB) using a frequency grid that is indicated by a synchronization raster that is categorized as the primary synchronization raster type. As described above, a presence property may be band-specific such that the network node 402 transmits multiple presence properties for a synchronization raster type, and each presence property may be associated with a respective band. Alternatively, or additionally, the network node 402 may indicate a time duration property (e.g., a time duration synchronization raster property) based at least in part on transmitting a flag that is set to a value that indicates that the associated synchronization raster information is always valid and/or may be used without a time condition. In a similar manner as the presence property, the time duration property (and/or the flag) may be band-specific based at least in part on the associated synchronization raster information being band-specific. A validity area property (e.g., a validity area synchronization raster property) may indicate a region in which the synchronization raster information is valid, such as a coverage area provided by the network node 402 and/or a region that is at least partially outside of the coverage area provided by the network node 402. In some aspects, a validity area property may be based at least in part on a location and/or a tracking area.

In some aspects, the network node 402 may transmit, one or more synchronization raster assistance information properties of synchronization raster assistance information that may be transmitted by the network node 402, such as a type of synchronization raster assistance information and/or a level of synchronization raster assistance information that is supported and/or indicated by the network node 402. Examples of a synchronization raster assistance information property may include a synchronization raster type (e.g., a primary synchronization raster type, a secondary synchronization raster type, a feature-specific synchronization raster type, and/or a category-specific synchronization raster type), intra public land mobile network (PLMN) information, inter-PLMN information, intra-band information, inter-band information, RedCap support, coverage enhancement support, low-power wakeup signal (LP-WUS) support, low-power synchronization signal (LP-SS) support, unmanned aerial vehicle support, relay support, and/or non-terrestrial network support. That is, the first network node 502 may advertise and/or indicate an availability of synchronization raster assistance information that is associated with a particular synchronization raster, and the particular synchronization raster may be used to locate a signal that provides initial access to a network that supports and/or is associated with a particular category, a particular feature, and/or a particular service, examples of which are provided above.

As shown by reference number 420, the UE 404 may perform a search for a signal (e.g., an SSB) using a synchronization raster that is categorized as the highest priority synchronization raster type that is selected by the UE 404. That is, the UE 404 may perform the search using a highest priority synchronization raster, and the highest priority synchronization raster may be a synchronization raster that is categorized as the highest priority synchronization raster type for the UE 404. Alternatively, or additionally, the UE 404 may perform the search based at least in part on synchronization signal raster type information that is indicated by the network node 402. For example, the UE 404 may perform the search using the GSCN range and/or the step size of the highest priority synchronization raster. Based at least in part on the highest priority synchronization raster, the UE 404 may search for a synchronization signal and/or for synchronization raster assistance information. For example, the UE 404 may search for an SSB and/or a different signal. In some aspects, the SSB and/or the different signal may carry the synchronization raster assistance information. Alternatively, or additionally, how the SSB and/or the different signal carries the synchronization raster assistance information (and/or how the UE 404 decodes and/or extracts the synchronization raster assistance information) may be specific to the synchronization raster type associated with the synchronization raster assistance information.

As shown by reference number 425, the UE 404 may iteratively perform a search based at least in part on the highest priority synchronization raster type and/or a synchronization raster that is categorized as the highest priority synchronization raster (e.g., a highest priority synchronization raster). For instance, the highest priority synchronization raster type selected by the UE 404 may be a first synchronization raster type, and the UE 404 may detect a first synchronization signal based at least in part on using a first synchronization raster that is categorized at the first synchronization type. The UE 404 may obtain synchronization raster assistance information (e.g., via the first synchronization signal), and the synchronization raster assistance information may be associated with locating a second synchronization signal based at least in part on a second synchronization raster that is categorized as a second synchronization raster type. The synchronization raster assistance information may indicate one or more parameters that are associated with the second synchronization raster, and the UE 404 may use the second synchronization raster to locate the second synchronization signal. As another example, the UE 404 may fail to detect the first synchronization signal using the first synchronization raster (e.g., the highest priority synchronization raster). Alternatively, or additionally, the UE 404 may fail to detect the first synchronization signal using multiple synchronization rasters that are categorized as the highest priority synchronization raster, such as a list of synchronization rasters specified in a table. In such a scenario, the UE may change from using synchronization raster(s) that are categorized as the highest priority synchronization raster type to using one or more second synchronization rasters that are categorized as a second highest priority synchronization raster type (e.g., one or more second highest priority synchronization rasters). The second highest priority synchronization raster type may be associated with locating synchronization raster assistance information, examples of which are provided below with regard to FIG. 5. To illustrate, the first synchronization raster that is categorized as a highest priority synchronization raster type may be associated with locating a signal that carries primary information, and a second synchronization raster that is categorized as a second highest priority synchronization raster type may be associated with locating a signal that indicates synchronization raster assistance information.

As shown by reference number 430, the network node 402 may transmit, and the UE 404 may receive, a synchronization signal (e.g., an SSB). In some aspects, the network node 402 may transmit the synchronization signal based at least in part on a synchronization raster that is the synchronization raster type indicated by the network node 402 as described with regard to reference number 415. To illustrate, the network node 402 may transmit the synchronization signal using a carrier frequency that is indicated by the synchronization raster as being an allowable carrier frequency for the synchronization signal. In a reciprocal manner, the UE 404 may detect the synchronization signal based at least in part on the synchronization raster.

As shown by reference number 435, the network node 402 and the UE 404 may perform an initial access procedure. For example, the synchronization signal may be an SSB that includes information that is associated with an initial access procedure. To illustrate, the UE 404 may decode a PSS and/or an SSS carried in the SSB and obtain any combination of timing information, frequency information, and/or a cell identifier associated with the network node 402. Alternatively or additionally, the UE 404 may decode a PBCH carried in the SSB to obtain system information (SI) that is associated with the network node 402. Based at least in part on information decoded from the SSB, the UE 404 may perform a RACH procedure to initiate communications with the network node 402. The network node 402 and the UE 404 may establish a connection based at least in part on the RACH procedure.

Synchronization raster types enable a UE to reduce a quantity of scans performed by the UE and/or reduce a quantity of synchronization rasters used by the UE to locate a synchronization signal and, consequently, reduce power consumption by the UE. For instance, a first scaling factor that is associated with a first synchronization raster type may indicate a scaling factor of 1, and a second scaling factor that is association with a second synchronization raster type may indicate a scaling factor of 5. Based at least in part on a power level at a UE satisfying a low power threshold, the UE may prioritize the second synchronization raster type to reduce the quantity of scans performed by the UE and, consequently, reduce power consumption at the UE.

As indicated above, FIG. 4 is provided as an example. Other examples may differ from what is described with regard to FIG. 4.

FIG. 5 is a diagram illustrating an example 500 of a wireless communication process between a first network node 502 (e.g., a first network node 110), a second network node 504 (e.g., a second network node 110), and a UE 506 (e.g., a UE 120), in accordance with the present disclosure. In the example 500, the UE 506 may perform a first search for synchronization raster assistance information that indicates one or more parameters that enable the UE 506 to perform a second search to locate primary information. To illustrate, the first network node 502 may transmit synchronization raster assistance information based at least in part on being a barred network node to the UE 506 as described below. Alternatively, or additionally the first network node 502 may transmit synchronization raster information to perform load balancing by using the synchronization raster information to direct the UE 506 to another network node and/or to provide synchronization raster assistance information that is linked to a different PLMN than the first network node 502. While the example 500 includes two network nodes, other examples may include a different number of network nodes (e.g., one network node or more than two network nodes). Various aspects described with regard to the example 500 may be combined with various aspects described with regard to the example 400 described above.

As shown by reference number 510, the UE 506 may prioritize synchronization raster types, such as by prioritizing multiple synchronization raster types in a similar manner as described with regard to reference number 410 of FIG. 4. In some aspects, based at least in part on prioritizing the multiple synchronization raster types, the UE 506 may select a highest priority synchronization raster.

As shown by reference number 515, a first network node 502 may transmit, and the UE 506 may receive, an indication of synchronization raster assistance information. Alternatively, or additionally, the first network node 502 may transmit an indication of a synchronization raster type and/or one or more synchronization raster properties as described with regard to FIG. 4. For instance, the first network node 502 may indicate and/or advertise support for synchronization raster assistance information and/or that the synchronization raster assistance information is available from the first network node 502, such as by transmitting a presence property (e.g., a presence synchronization raster property) that indicates that synchronization raster assistance information is available from the first network node 502. For instance, the first network node 502 may transmit a presence property for a synchronization raster type that is associated with indicating synchronization raster assistance information. The first network node 502 may transmit the indication of synchronization raster assistance information in an SSB, a master information block (MIB), a reference signal, a system information payload (e.g., remaining minimum system information (RMSI) and/or light SI that is a subset of SI), and/or scheduling PDCCH.

The UE 506 may receive the indication of synchronization raster assistance information based at least in part on performing a search using the highest priority synchronization raster in a similar manner as described with regard to reference number 420 of FIG. 4. For instance, the UE 506 may prioritize a synchronization raster type that is associated with obtaining synchronization raster assistance information, and may perform a search using the highest priority synchronization raster, resulting in the UE 506 receiving the indication from the first network node 502.

In some aspects, the first network node 502 may transmit, as at least part of the synchronization raster assistance information, one or more synchronization raster assistance information properties of the synchronization raster assistance information, such as a type of synchronization raster assistance information and/or a level of synchronization raster assistance information that is supported and/or indicated by the first network node 502. Examples of a synchronization raster assistance information property may include a synchronization raster type (e.g., a primary synchronization raster type, a secondary synchronization raster type, a feature-specific synchronization raster type, and/or a category-specific synchronization raster type), intra-PLMN information, inter-PLMN information, intra-band information, inter-band information, RedCap support, coverage enhancement support, LP-WUS support, LP-SS support, unmanned aerial vehicle support, relay support, and/or non-terrestrial network support. That is, the first network node 502 may advertise and/or indicate an availability of synchronization raster assistance information that is associated with a particular synchronization raster, and the particular synchronization raster may be used to locate a signal that provides initial access to a network that supports and/or is associated with a particular category, a particular feature, and/or a particular service, examples of which are provided above.

Alternatively, or additionally, the first network node 502 may indicate acquisition information that is associated with obtaining the synchronization raster assistance information, such as by indicating which SI carries the synchronization raster assistance information, indicating the associated resources that carry the synchronization raster assistance information, and/or indicating a configuration that is associated with obtaining the synchronization raster assistance information. In some aspects, the configuration may indication information associated with a channel that carries the synchronization raster assistance information, and examples of information may be indicated by the configuration may include an identifier (e.g., a radio network temporary identifier (RNTI), an MCS range and/or MCS value, a beam identifier, a QCL relationship, and/or a transmit power level.

By using a first transmission to indicate that synchronization raster assistance information is available and a second transmission to indicate the synchronization raster assistance information content, the first network node 502 may transmit an indication that the synchronization raster assistance information is available more frequently, relative to transmitting the content of the synchronization raster assistance information. To illustrate, the first transmission used to indicate the availability of synchronization raster assistance information may use less signaling overhead relative to the second transmission that includes the content. Thus, the first network node 502 may transmit the indication that synchronization raster assistance information is available more frequently to notify the UE 506 that the synchronization raster assistance information is available. In some aspects, the transmission of the synchronization raster assistance information content may be performed by the first network node 502 on-demand as described below. In other aspects, the transmission of the synchronization raster assistance information content may be performed periodically. For instance, the first network node 502 may transmit the indication of synchronization raster assistance information at a first periodicity, and the synchronization raster assistance information content at a second periodicity that has a longer period interval relative to the first periodicity.

In some aspects, the first network node 502 may indicate and/or advertise that additional information is available via the synchronization raster assistance information. Based at least in part on receiving the indication that the additional information is available, the UE 506 may proceed with receiving and/or decoding other channels and/or other signals that are indicated by a synchronization raster that is used by the UE 506, such as a PBCH in an SSB that is received by the UE 506 via another channel and indicates that no RMSI is available and/or that initial access via the first network node 502 is barred for the UE 506.

As shown by reference number 520, the UE 506 may transmit, and the first network node 502 may receive, a request for the synchronization raster assistance information. To illustrate, the UE 506 may transmit the request based at least in part on the synchronization raster assistance information being available on-demand. While the example 500 includes the UE 506 transmitting the request for the synchronization raster assistance information, other examples may not include the UE 506 transmitting the request. Accordingly, the UE 506 transmitting a request for the synchronization raster assistance information may be optional, which is shown in FIG. 5 through the use of a dashed line.

In some aspects, the UE 506 may transmit the request in an uplink wakeup signal (UL-WUS). Alternatively, or additionally, the UE 506 may indicate additional information in the request that indicates a requested configuration of the synchronization raster assistance information, such as an associated PLMN identifier to request synchronization raster assistance information that is associated with the PLMN, a supported feature to request synchronization raster assistance information that is associated with the supported feature, and/or a synchronization raster type to request synchronization raster assistance information that is associated with the synchronization raster type. While described with regard to the example 500 shown by FIG. 5, other examples may include the UE 506 transmitting a request for the synchronization raster assistance information in alternate or additional scenarios, such as the example 400 described with regard to FIG. 4.

As shown by reference number 525, the first network node 502 may transmit, and the UE 506 may receive, the synchronization raster assistance information. The synchronization raster assistance information may provide information about an additional synchronization raster and/or may enable the UE 506 to locate a suitable and/or relevant network node for cell selection, such as a network node that includes support for a requested supported feature. That is, the synchronization raster assistance information may provide information about the additional synchronization raster, and the additional synchronization raster may be used by the UE 506 to locate a signal associated with the relevant network node. In some aspects, the first network node 502 may be a barred network node (e.g., to the UE 506) that provides synchronization raster assistance information for another network node that is not a barred network node to the UE 506. For instance, the first network node 502 may not include support for a requested feature and/or a requested category by the UE 506 and, consequently, may be a barred network node to the UE 506 for the requested feature and/or the requested category. Accordingly, the first network node 502 may transmit synchronization raster assistance information that is associated with an additional synchronization raster, and the additional synchronization raster enables the UE 506 to locate a synchronization signal (and/or other information) to gain access to another network node that includes support for the requested feature. Accordingly, while access to the first network node 502 may be barred for the UE 506 based at least in part on a particular category and/or a particular feature, the first network node 502 may provide synchronization raster assistance information for other network nodes accessible to the UE 506. In other examples, the first network node 502 may not be a barred network node that transmits the synchronization raster assistance information, such as in a scenario in which the first network node 502 transmits the synchronization raster assistance information to perform load balancing.

The UE 506 may continue to receive and decode information from the first network node 502 even though the first network node 502 may be a barred network node to the UE 506. To illustrate, the UE 506 may receive an indication that the first network node 502 is a barred network node (e.g., to the UE 506) in an MIB and/or an RMSI, and the UE 506 may continue to receive and decode an SIB type 2 (SIB2), an SIB type 3 (SIB3), and/or an SIB type 4 (SIB4) from the first network node 502 to obtain information about a neighbor network node. In some aspects, the SIB2, the SIB3, and/or the SIB4 may include assistance information about one or more network nodes that are neighbors to the first network node 502 and belong to a different PLMN than the first network node 502. Alternatively, or additionally, the SIB2, the SIB3, and/or the SIB4 may include at least some synchronization raster assistance information, such as the synchronization raster assistance information described herein.

In some aspects, the first network node 502 may be associated with a first PLMN and may transmit synchronization raster assistance information that is associated with a second network node (e.g., the second network node 504) that is associated with a second PLMN. To illustrate, the first network node 502 and the second network node 504 may communicate respective synchronization raster information via a backhaul link. Alternatively, or additionally, the first network node 502 and the second network node 504 may communicate a supported feature and/or a supported category that is associated with the respective synchronization raster information. Accordingly, the first network node 502 may transmit synchronization raster information that is associated with another PLMN than the PLMN that is associated with the first network node 502.

As described above, the synchronization raster assistance information may provide information that enables the UE 506 to locate a synchronization signal, information, and/or other signaling that enables the UE 506 to perform an initial access procedure to another network node. Examples of information that may be included and/or indicated by the synchronization raster assistance information include any combination of one or more PLMN-specific raster lists, a respective synchronization raster type (e.g., primary or secondary) for each PLMN-specific raster list of the one or more PLMN-specific raster lists, a respective cell identifier associated with each PLMN-specific raster list of the one or more PLMN-specific raster lists (and/or a respective discovery reference signal (DRS) identifier), a respective discovery reference signal identifier associated with each PLMN-specific raster list of the one or more PLMN-specific raster lists, a respective cell type (e.g., 5G, 6G, NES, non-NES, macro, small, stationary, mobile, eco-friendly, not co-friendly) associated with each PLMN-specific raster list of the one or more PLMN-specific raster lists, a respective supported feature (e.g., RedCap support, coverage enhancement support, LP-WUS support, LP-SS support, unmanned aerial vehicle support, relay support, and/or non-terrestrial network support) associated with each PLMN-specific raster list of the one or more PLMN-specific raster lists, one or more PLMN-specific raster unsupported-index lists, one or more PLMN-specific frequency band supported-offset lists, and/or one or more PLMN-specific frequency band unsupported-offset lists.

Each PLMN-specific raster list may be associated with one or more frequency bands and/or a PLMN identifier. Alternatively, or additionally, the PLMN-specific raster list may be associated with and/or may indicate one or more offsets (e.g., frequency shifts) that are relative to a reference frequency. In some aspects, each PLMN-specific raster list may indicate one or more network nodes and/or cells that are included in the associated PLMN. A PLMN-specific raster unsupported-index list may indicate one or more indices that map to and/or indicate unsupported frequency rasters for the associated PLMN. Alternatively, or additionally, a PLMN-specific frequency band supported-offset list may indicate one or more supported offsets in a frequency band for the associated PLMN, and a PLMN-specific frequency band unsupported-offset list may indicate one or more unsupported offsets in the frequency band for the associated PLMN.

In some aspects, the synchronization raster assistance information transmitted by the first network node 502 may be associated with a region and/or a UE operating at a location within the region. For instance, synchronization raster assistance information may be associated with a coverage area (e.g., that is provided by the first network node 502 or another network node) and/or a region that is at least partially outside of the coverage area (e.g., a tracking area). To illustrate, the synchronization raster assistance information may be valid for the associated region and/or invalid outside of the associated region. Alternatively, or additionally, the synchronization raster assistance information may be associated with an expiration time and/or a time duration. Prior to the expiration time and/or prior to expiration of the time duration, the synchronization raster assistance information may be valid and, otherwise, the synchronization raster assistance information may be invalid. As one example, the expiration time and/or the time duration may be based at least in part on cell mobility and/or a network node changing an operating mode for NES. Based at least in part on determining that the synchronization raster assistance information is invalid, the UE 506 may discard the synchronization raster assistance information.

In some scenarios, such as in a scenario in which the first network node 502 transmits the synchronization raster assistance information on-demand and/or based at least in part on receiving a request from the UE 506, the first network node 502 may transmit selective synchronization raster assistance information. To illustrate, the first network node 502 may select and transmit synchronization raster assistance information based at least in part on load balancing, such as by selecting synchronization raster assistance information that directs the UE 506 to a network node that has lower demand relative to another network node. As another example, the first network node 502 may select and transmit synchronization raster assistance information that is associated with a network node operating in a non-NES mode. That is, the first network node 502 may not select and/or may not transmit synchronization raster assistance information that is associated with a network node that is operating in the NES mode, to deter the UE 506 from attempting to establish a connection with the network mode.

As shown by reference number 530, the UE 506 may perform a search using at least the synchronization raster assistance information, such as by performing a search in a similar manner as described with regard to reference number 420 of FIG. 4. Alternatively, or additionally, the UE 506 may perform the search using the highest priority synchronization raster type in combination with the synchronization raster assistance information. As shown by reference number 535, the search performed by the UE 506 may be an interactive process.

As shown by reference number 540, a second network node 504 may transmit, and the UE 506 may receive, a synchronization signal. For instance, the second network node 504 may transmit the synchronization signal based at least in part on the information indicated in the synchronization raster assistance information, and the UE 506 may detect the synchronization signal based at least in part on the information indicated in the synchronization raster assistance information. While the example 500 includes the second network node 504 transmitting the synchronization, other examples may include a same network node (e.g., the first network node 502) transmitting the synchronization raster assistance information and the synchronization signal (e.g., that indicates the initial access information).

As shown by reference number 545, the second network node 504 and the UE 506 may perform an initial access procedure. To illustrate, the second network node 504 and the UE 506 may perform the initial access procedure in a similar manner as described with regard to reference number 435 of FIG. 4.

Synchronization raster types enable a UE to reduce a quantity of scans performed by the UE and/or reduce a quantity of synchronization rasters used by the UE to locate a synchronization signal and, consequently, reduce power consumption by the UE. To illustrate, different synchronization raster types may be associated with different scaling factors and/or different step sizes for scanning a range of GSCNs, and a UE may prioritize synchronization rasters that have a larger scaling factor and/or a larger step size to reduce the quantity of scans performed by the UE and, consequently, reduce power consumption at the UE.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with synchronization raster types.

As shown in FIG. 6, in some aspects, process 600 may include prioritizing, based at least in part on multiple synchronization raster types, two or more synchronization rasters according to their respective synchronization raster types included in the multiple synchronization raster types to select a highest priority synchronization raster in the two or more synchronization rasters (block 610). For example, the UE (e.g., using communication manager 1006, depicted in FIG. 10) may prioritize, based at least in part on multiple synchronization raster types, two or more synchronization rasters according to their respective synchronization raster types included in the multiple synchronization raster types to select a highest priority synchronization raster in the two or more synchronization rasters, as described above.

As further shown in FIG. 6, in some aspects, process 600 may include searching for a synchronization signal based at least in part on the highest priority synchronization raster (block 620). For example, the UE (e.g., using communication manager 1006, depicted in FIG. 10) may search for a synchronization signal based at least in part on the highest priority synchronization raster, as described above.

Process 600 may include additional aspects, such as any single aspect or any combination of aspects described below and/or in connection with one or more other processes described elsewhere herein.

In a first aspect, the multiple synchronization raster types include at least a primary synchronization raster type, and a secondary synchronization raster type.

In a second aspect, the primary synchronization raster type is associated with a first scaling factor, and the secondary synchronization raster type is associated with a second scaling factor that is different from the first scaling factor.

In a third aspect, the highest priority synchronization raster is a first synchronization raster, and process 600 includes detecting the synchronization signal based at least in part on the first synchronization raster, and obtaining, using at least the synchronization signal, assistance information that is associated with locating a second synchronization raster.

In a fourth aspect, process 600 includes failing to detect the synchronization signal using the highest priority synchronization raster, and searching for the synchronization signal using a second highest priority synchronization raster in the two or more synchronization rasters.

In a fifth aspect, the second highest priority synchronization raster is associated with locating assistance information associated with one or more additional synchronization rasters.

In a sixth aspect, process 600 includes receiving an indication of one or more synchronization raster properties, the one or more synchronization raster properties including at least one of a presence property, a time duration property, or a validity area property.

In a seventh aspect, the one or more synchronization raster properties include one or more band-specific synchronization raster properties.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with synchronization raster types.

As shown in FIG. 7, in some aspects, process 700 may include receiving an indication of synchronization raster assistance information that is associated with a synchronization signal associated with access to a network, the indication of the synchronization raster assistance information specifying a synchronization raster property of the synchronization raster assistance information (block 710). For example, the UE (e.g., using reception component 1002 and/or communication manager 1006, depicted in FIG. 10) may receive an indication of synchronization raster assistance information that is associated with a synchronization signal associated with access to a network, the indication of the synchronization raster assistance information specifying a synchronization raster property of the synchronization raster assistance information, as described above.

As further shown in FIG. 7, in some aspects, process 700 may include receiving the synchronization raster assistance information (block 720). For example, the UE (e.g., using reception component 1002 and/or communication manager 1006, depicted in FIG. 10) may receive the synchronization raster assistance information, as described above.

As further shown in FIG. 7, in some aspects, process 700 may include searching for the synchronization signal using the synchronization raster assistance information (block 730). For example, the UE (e.g., using communication manager 1006, depicted in FIG. 10) may search for the synchronization signal using the synchronization raster assistance information, as described above.

Process 700 may include additional aspects, such as any single aspect or any combination of aspects described below and/or in connection with one or more other processes described elsewhere herein.

In a first aspect, receiving the indication of the synchronization raster assistance information includes receiving the indication of the synchronization raster assistance information from a first network node that is associated with a first PLMN, and the synchronization raster assistance information is associated with access to the network via a second network node that is associated with a second PLMN.

In a second aspect, receiving the indication of the synchronization raster assistance information includes receiving the indication of the synchronization raster assistance information from a barred network node.

In a third aspect, the barred network node is a first network node that is barred based at least in part on a category, and the synchronization raster assistance information is associated with a second network node that is not barred for the category.

In a fourth aspect, the synchronization raster property includes at least one of a synchronization raster type, PLMN information, inter-PLMN information, intra-band information, inter-band information, redcap support, coverage enhancement support, low-power wakeup signal support, low-power synchronization signal support, unmanned aerial vehicle support, relaying support, or non-terrestrial network support.

In a fifth aspect, the indication of the synchronization raster assistance information includes acquisition information for the synchronization raster assistance information.

In a sixth aspect, the synchronization raster assistance information includes at least one of one or more PLMN-specific raster lists, a respective synchronization raster type for each PLMN-specific raster list of the one or more PLMN-specific raster lists, a respective cell identifier associated with each PLMN-specific raster list of the one or more PLMN-specific raster lists, a respective discovery reference signal identifier associated with each PLMN-specific raster list of the one or more PLMN-specific raster lists, a respective cell type associated with each PLMN-specific raster list of the one or more PLMN-specific raster lists, a respective supported feature associated with each PLMN-specific raster list of the one or more PLMN-specific raster lists, one or more PLMN-specific raster unsupported-index lists, one or more PLMN-specific frequency band supported-offset lists, or one or more PLMN-specific frequency band unsupported-offset lists.

In a seventh aspect, the synchronization raster assistance information is associated with a coverage area, or a region that is at least partially outside of the coverage area.

In an eighth aspect, the synchronization raster assistance information is associated with an expiration time.

In a ninth aspect, receiving the indication of the synchronization raster assistance information includes receiving the indication of the synchronization raster assistance information in at least one of a synchronization signal block, a master information block, or a reference signal.

In a tenth aspect, receiving the indication of the synchronization raster assistance information includes receiving the indication of the synchronization raster assistance information in first signaling, and receiving the synchronization raster assistance information in second signaling that is different from the first signaling.

In an eleventh aspect, receiving the indication of the synchronization raster assistance information includes receiving the indication of the synchronization raster assistance information as a broadcast message.

In a twelfth aspect, process 700 includes transmitting a request for the synchronization raster information based at least in part on receiving the indication of the synchronization raster assistance information, and receiving the synchronization raster assistance information in an on-demand message.

In a thirteenth aspect, the request indicates at least one of an associated public land mobile network identifier, a supported feature, or a synchronization raster type.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with synchronization raster types.

As shown in FIG. 8, in some aspects, process 800 may include transmitting an indication of a supported synchronization raster type (block 810). For example, the network node (e.g., using transmission component 1104 and/or communication manager 1106, depicted in FIG. 11) may transmit an indication of a supported synchronization raster type, as described above.

As further shown in FIG. 8, in some aspects, process 800 may include transmitting a synchronization signal based at least in part on a synchronization raster that is the supported synchronization raster type (block 820). For example, the network node (e.g., using transmission component 1104 and/or communication manager 1106, depicted in FIG. 11) may transmit a synchronization signal based at least in part on a synchronization raster that is the supported synchronization raster type, as described above.

Process 800 may include additional aspects, such as any single aspect or any combination of aspects described below and/or in connection with one or more other processes described elsewhere herein.

In a first aspect, the supported synchronization raster type is one of multiple synchronization raster types that include at least a primary synchronization raster type, and a secondary synchronization raster type.

In a second aspect, the primary synchronization raster type is associated with a first scaling factor, and the secondary synchronization raster type is associated with a second scaling factor that is different from the first scaling factor.

In a third aspect, the indication of the supported synchronization raster type is a first indication, and process 800 includes transmitting a second indication of one or more synchronization raster properties, the one or more synchronization raster properties including at least one of a presence property, a time duration property, or a validity area property.

In a fourth aspect, the one or more synchronization raster properties include one or more band-specific synchronization raster properties.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with synchronization raster types.

As shown in FIG. 9, in some aspects, process 900 may include transmitting, in first signaling, an indication of synchronization raster assistance information that is associated with a synchronization signal associated with access to a network, the indication of the synchronization raster assistance information specifying a synchronization raster property of the synchronization raster assistance information (block 910). For example, the network node (e.g., using transmission component 1104 and/or communication manager 1106, depicted in FIG. 11) may transmit, in first signaling, an indication of synchronization raster assistance information that is associated with a synchronization signal associated with access to a network, the indication of the synchronization raster assistance information specifying a synchronization raster property of the synchronization raster assistance information, as described above.

As further shown in FIG. 9, in some aspects, process 900 may include transmitting, in second signaling, the synchronization raster assistance information (block 920). For example, the network node (e.g., using transmission component 1104 and/or communication manager 1106, depicted in FIG. 11) may transmit, in second signaling, the synchronization raster assistance information, as described above.

Process 900 may include additional aspects, such as any single aspect or any combination of aspects described below and/or in connection with one or more other processes described elsewhere herein.

In a first aspect, the network node is associated with a first PLMN, and the synchronization raster assistance information is associated with access to the network via a second network node that is associated with a second PLMN.

In a second aspect, transmitting the indication of the synchronization raster assistance information includes transmitting the indication of the synchronization raster assistance information as a barred network node based at least in part on a category, and the synchronization raster assistance information is associated with a second network node that is not barred for the category.

In a third aspect, the synchronization raster property includes at least one of a synchronization raster type, PLMN information, inter-PLMN information, intra-band information, inter-band information, redcap support, coverage enhancement support, low-power wakeup signal support, low-power synchronization signal support, unmanned aerial vehicle support, relaying support, or non-terrestrial network support.

In a fourth aspect, the indication of the synchronization raster assistance information includes acquisition information for the synchronization raster assistance information.

In a fifth aspect, the synchronization raster assistance information includes at least one of one or more PLMN-specific raster lists, a respective synchronization raster type for each PLMN-specific raster list of the one or more PLMN-specific raster lists, a respective cell identifier associated with each PLMN-specific raster list of the one or more PLMN-specific raster lists, a respective discovery reference signal identifier associated with each PLMN-specific raster list of the one or more PLMN-specific raster lists, a respective cell type associated with each PLMN-specific raster list of the one or more PLMN-specific raster lists, a respective supported feature associated with each PLMN-specific raster list of the one or more PLMN-specific raster lists, one or more PLMN-specific raster unsupported-index lists, one or more PLMN-specific frequency band supported-offset lists, or one or more PLMN-specific frequency band unsupported-offset lists.

In a sixth aspect, the synchronization raster assistance information is associated with a coverage area, or a region that is at least partially outside of the coverage area.

In a seventh aspect, the synchronization raster assistance information is associated with an expiration time.

In an eighth aspect, transmitting the indication of the synchronization raster assistance information includes transmitting the indication of the synchronization raster assistance information in at least one of a synchronization signal block, a master information block, or a reference signal.

In a ninth aspect, transmitting the indication of the synchronization raster assistance information includes transmitting the indication of the synchronization raster assistance information as a broadcast message.

In a tenth aspect, process 900 includes receiving a request for the synchronization raster information based at least in part on receiving the indication of the synchronization raster assistance information, and transmitting the synchronization raster assistance information includes transmitting the synchronization raster assistance information in an on-demand message.

In an eleventh aspect, the request indicates at least one of an associated public land mobile network identifier, a supported feature, or a synchronization raster type.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 3-5. Additionally, or alternatively, the apparatus 1000 may be configured to perform one or more processes described herein, such as process 600 of FIG. 6, process 700 of FIG. 7, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may prioritize, based at least in part on multiple synchronization raster types, two or more synchronization rasters according to their respective synchronization raster types included in the multiple synchronization raster types to select a highest priority synchronization raster in the two or more synchronization rasters. The communication manager 1006 may search for a synchronization signal based at least in part on the highest priority synchronization raster.

In some aspects, the communication manager 1006 may fail to detect the synchronization signal using the highest priority synchronization raster. The communication manager 1006 may search for the synchronization signal using a second highest priority synchronization raster in the two or more synchronization rasters.

The reception component 1002 may receive an indication of one or more synchronization raster properties, and the one or more synchronization raster properties may include at least one of a presence property, a time duration property, or a validity area property.

In some aspects, the reception component 1002 may receive an indication of synchronization raster assistance information that is associated with a synchronization signal associated with access to a network, the indication of the synchronization raster assistance information specifying a synchronization raster property of the synchronization raster assistance information. The reception component 1002 may receive the synchronization raster assistance information. The communication manager 1006 may search for the synchronization signal using the synchronization raster assistance information.

The transmission component 1004 may transmit a request for the synchronization raster information based at least in part on receiving the indication of the synchronization raster assistance information. In some aspects, the reception component 1002 may receive the synchronization raster assistance information in an on-demand message.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 3-5. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit an indication of a supported synchronization raster type. The transmission component 1104 may transmit a synchronization signal based at least in part on a synchronization raster that is the supported synchronization raster type.

Alternatively, or additionally, the transmission component 1104 may transmit, in first signaling, an indication of synchronization raster assistance information that is associated with a synchronization signal associated with access to a network, the indication of the synchronization raster assistance information specifying a synchronization raster property of the synchronization raster assistance information. The transmission component 1104 may transmit, in second signaling, the synchronization raster assistance information. The reception component 1102 may receive a request for the synchronization raster information based at least in part on receiving the indication of the synchronization raster assistance information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: prioritizing, based at least in part on multiple synchronization raster types, two or more synchronization rasters according to their respective synchronization raster types included in the multiple synchronization raster types to select a highest priority synchronization raster in the two or more synchronization rasters; and searching for a synchronization signal based at least in part on the highest priority synchronization raster.

Aspect 2: The method of Aspect 1, wherein the multiple synchronization raster types include at least: a primary synchronization raster type, and a secondary synchronization raster type.

Aspect 3: The method of Aspect 2, wherein the primary synchronization raster type is associated with a first scaling factor, and wherein the secondary synchronization raster type is associated with a second scaling factor that is different from the first scaling factor.

Aspect 4: The method of any of Aspects 1-3, wherein the highest priority synchronization raster is a first synchronization raster, and wherein the method further comprises: detecting the synchronization signal based at least in part on the first synchronization raster; and obtaining, using at least the synchronization signal, assistance information that is associated with locating a second synchronization raster.

Aspect 5: The method of any of Aspects 1-4, further comprising: failing to detect the synchronization signal using the highest priority synchronization raster; and searching for the synchronization signal using a second highest priority synchronization raster in the two or more synchronization rasters.

Aspect 6: The method of Aspect 5, wherein the second highest priority synchronization raster is associated with locating assistance information associated with one or more additional synchronization rasters.

Aspect 7: The method of any of Aspects 1-6, further comprising: receiving an indication of one or more synchronization raster properties, the one or more synchronization raster properties including at least one of: a presence property, a time duration property, or a validity area property.

Aspect 8: The method of Aspect 7, wherein the one or more synchronization raster properties include one or more band-specific synchronization raster properties.

Aspect 9: A method of wireless communication performed by a user equipment (UE), comprising: receiving an indication of synchronization raster assistance information that is associated with a synchronization signal associated with access to a network, the indication of the synchronization raster assistance information specifying a synchronization raster property of the synchronization raster assistance information; receiving the synchronization raster assistance information; and searching for the synchronization signal using the synchronization raster assistance information.

Aspect 10: The method of Aspect 9, wherein receiving the indication of the synchronization raster assistance information comprises: receiving the indication of the synchronization raster assistance information from a first network node that is associated with a first public land mobile network (PLMN), wherein the synchronization raster assistance information is associated with access to the network via a second network node that is associated with a second PLMN.

Aspect 11: The method of any of Aspects 9-10, wherein receiving the indication of the synchronization raster assistance information comprises: receiving the indication of the synchronization raster assistance information from a barred network node.

Aspect 12: The method of Aspect 11, wherein the barred network node is a first network node that is barred based at least in part on a category, and wherein the synchronization raster assistance information is associated with a second network node that is not barred for the category.

Aspect 13: The method of any of Aspects 9-12, wherein the synchronization raster property comprises at least one of: a synchronization raster type, intra public land mobile network (PLMN) information, inter-PLMN information, intra-band information, inter-band information, redcap support, coverage enhancement support, low-power wakeup signal support, low-power synchronization signal support, unmanned aerial vehicle support, relay support, or non-terrestrial network support.

Aspect 14: The method of any of Aspects 9-13, wherein the indication of the synchronization raster assistance information comprises acquisition information for the synchronization raster assistance information.

Aspect 15: The method of any of Aspects 9-14, wherein the synchronization raster assistance information comprises at least one of: one or more public land mobile network (PLMN)-specific raster lists, a respective synchronization raster type for each PLMN-specific raster list of the one or more PLMN-specific raster lists, a respective cell identifier associated with each PLMN-specific raster list of the one or more PLMN-specific raster lists, a respective discovery reference signal identifier associated with each PLMN-specific raster list of the one or more PLMN-specific raster lists, a respective cell type associated with each PLMN-specific raster list of the one or more PLMN-specific raster lists, a respective supported feature associated with each PLMN-specific raster list of the one or more PLMN-specific raster lists, one or more PLMN-specific raster unsupported-index lists, one or more PLMN-specific frequency band supported-offset lists, or one or more PLMN-specific frequency band unsupported-offset lists.

Aspect 16: The method of any of Aspects 9-15, wherein the synchronization raster assistance information is associated with: a coverage area, or a region that is at least partially outside of the coverage area.

Aspect 17: The method of any of Aspects 9-16, wherein the synchronization raster assistance information is associated with an expiration time.

Aspect 18: The method of any of Aspects 9-17, wherein receiving the indication of the synchronization raster assistance information comprises: receiving the indication of the synchronization raster assistance information in at least one of: a synchronization signal block, a master information block, or a reference signal.

Aspect 19: The method of any of Aspects 9-18, wherein receiving the indication of the synchronization raster assistance information comprises: receiving the indication of the synchronization raster assistance information in first signaling, and receiving the synchronization raster assistance information in second signaling that is different from the first signaling.

Aspect 20: The method of any of Aspects 9-19, wherein receiving the indication of the synchronization raster assistance information comprises: receiving the indication of the synchronization raster assistance information as a broadcast message.

Aspect 21: The method of any of Aspects 9-20, further comprising: transmitting a request for the synchronization raster information based at least in part on receiving the indication of the synchronization raster assistance information; and receiving the synchronization raster assistance information in an on-demand message.

Aspect 22: The method of Aspect 21, wherein the request indicates at least one of: an associated public land mobile network identifier, a supported feature, or a synchronization raster type.

Aspect 23: A method of wireless communication performed by a network node, comprising: transmitting an indication of a supported synchronization raster type; and transmitting a synchronization signal based at least in part on a synchronization raster that is the supported synchronization raster type.

Aspect 24: The method of Aspect 23, wherein the supported synchronization raster type is one of multiple synchronization raster types that include at least: a primary synchronization raster type, and a secondary synchronization raster type.

Aspect 25: The method of Aspect 24, wherein the primary synchronization raster type is associated with a first scaling factor, and wherein the secondary synchronization raster type is associated with a second scaling factor that is different from the first scaling factor.

Aspect 26: The method of any of Aspects 23-25, wherein the indication of the supported synchronization raster type is a first indication, and wherein the method further comprises: transmitting a second indication of one or more synchronization raster properties, the one or more synchronization raster properties including at least one of: a presence property, a time duration property, or a validity area property.

Aspect 27: The method of Aspect 26, wherein the one or more synchronization raster properties include one or more band-specific synchronization raster properties.

Aspect 28: A method of wireless communication performed by a network node, comprising: transmitting, in first signaling, an indication of synchronization raster assistance information that is associated with a synchronization signal associated with access to a network, the indication of the synchronization raster assistance information specifying a synchronization raster property of the synchronization raster assistance information; and transmitting, in second signaling, the synchronization raster assistance information.

Aspect 29: The method of Aspect 28, wherein the network node is associated with a first public land mobile network (PLMN), and wherein the synchronization raster assistance information is associated with access to the network via a second network node that is associated with a second PLMN.

Aspect 30: The method of any of Aspects 28-29, wherein transmitting the indication of the synchronization raster assistance information comprises: transmitting the indication of the synchronization raster assistance information as a barred network node based at least in part on a category, and wherein the synchronization raster assistance information is associated with a second network node that is not barred for the category.

Aspect 31: The method of any of Aspects 28-30, wherein the synchronization raster property comprises at least one of: a synchronization raster type, intra public land mobile network (PLMN) information, inter-PLMN information, intra-band information, inter-band information, redcap support, coverage enhancement support, low-power wakeup signal support, low-power synchronization signal support, unmanned aerial vehicle support, relay support, or non-terrestrial network support.

Aspect 32: The method of any of Aspects 28-31, wherein the indication of the synchronization raster assistance information comprises acquisition information for the synchronization raster assistance information.

Aspect 33: The method of any of Aspects 28-32, wherein the synchronization raster assistance information comprises at least one of: one or more public land mobile network (PLMN)-specific raster lists, a respective synchronization raster type for each PLMN-specific raster list of the one or more PLMN-specific raster lists, a respective cell identifier associated with each PLMN-specific raster list of the one or more PLMN-specific raster lists, a respective discovery reference signal identifier associated with each PLMN-specific raster list of the one or more PLMN-specific raster lists, a respective cell type associated with each PLMN-specific raster list of the one or more PLMN-specific raster lists, a respective supported feature associated with each PLMN-specific raster list of the one or more PLMN-specific raster lists, one or more PLMN-specific raster unsupported-index lists, one or more PLMN-specific frequency band supported-offset lists, or one or more PLMN-specific frequency band unsupported-offset lists.

Aspect 34: The method of any of Aspects 28-33, wherein the synchronization raster assistance information is associated with: a coverage area, or a region that is at least partially outside of the coverage area.

Aspect 35: The method of any of Aspects 28-34, wherein the synchronization raster assistance information is associated with an expiration time.

Aspect 36: The method of any of Aspects 28-35, wherein transmitting the indication of the synchronization raster assistance information comprises: transmitting the indication of the synchronization raster assistance information in at least one of: a synchronization signal block, a master information block, or a reference signal.

Aspect 37: The method of any of Aspects 28-36, wherein transmitting the indication of the synchronization raster assistance information comprises: transmitting the indication of the synchronization raster assistance information as a broadcast message.

Aspect 38: The method of any of Aspects 28-37, further comprising: receiving a request for the synchronization raster information based at least in part on receiving the indication of the synchronization raster assistance information, wherein transmitting the synchronization raster assistance information comprises: transmitting the synchronization raster assistance information in an on-demand message. wherein transmitting the synchronization raster assistance information comprises: transmitting the synchronization raster assistance information in an on-demand message.

Aspect 39: The method of Aspect 38, wherein the request indicates at least one of: an associated public land mobile network identifier, a supported feature, or a synchronization raster type.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-8.

Aspect 41: An apparatus for wireless communication at a device, the apparatus comprising one or more memories and one or more processors coupled to the one or more memories, the one or more processors configured to cause the device to perform the method of one or more of Aspects 1-8.

Aspect 42: An apparatus for wireless communication, the apparatus comprising at least one means for performing the method of one or more of Aspects 1-8.

Aspect 43: A non-transitory computer-readable medium storing code for wireless communication, the code comprising instructions executable by one or more processors to perform the method of one or more of Aspects 1-8.

Aspect 44: A non-transitory computer-readable medium storing a set of instructions for wireless communication, the set of instructions comprising one or more instructions that, when executed by one or more processors of a device, cause the device to perform the method of one or more of Aspects 1-8.

Aspect 45: A device for wireless communication, the device comprising a processing system that includes one or more processors and one or more memories coupled with the one or more processors, the processing system configured to cause the device to perform the method of one or more of Aspects 1-8.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-8.

Aspect 47: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 9-22.

Aspect 48: An apparatus for wireless communication at a device, the apparatus comprising one or more memories and one or more processors coupled to the one or more memories, the one or more processors configured to cause the device to perform the method of one or more of Aspects 9-22.

Aspect 49: An apparatus for wireless communication, the apparatus comprising at least one means for performing the method of one or more of Aspects 9-22.

Aspect 50: A non-transitory computer-readable medium storing code for wireless communication, the code comprising instructions executable by one or more processors to perform the method of one or more of Aspects 9-22.

Aspect 51: A non-transitory computer-readable medium storing a set of instructions for wireless communication, the set of instructions comprising one or more instructions that, when executed by one or more processors of a device, cause the device to perform the method of one or more of Aspects 9-22.

Aspect 52: A device for wireless communication, the device comprising a processing system that includes one or more processors and one or more memories coupled with the one or more processors, the processing system configured to cause the device to perform the method of one or more of Aspects 9-22.

Aspect 53: An apparatus for wireless communication at a device, the apparatus comprising one or more memories and one or more processors coupled to the one or more memories, the one or more processors individually or collectively configured to cause the device to perform the method of one or more of Aspects 9-22.

Aspect 54: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 23-27.

Aspect 55: An apparatus for wireless communication at a device, the apparatus comprising one or more memories and one or more processors coupled to the one or more memories, the one or more processors configured to cause the device to perform the method of one or more of Aspects 23-27.

Aspect 56: An apparatus for wireless communication, the apparatus comprising at least one means for performing the method of one or more of Aspects 23-27.

Aspect 57: A non-transitory computer-readable medium storing code for wireless communication, the code comprising instructions executable by one or more processors to perform the method of one or more of Aspects 23-27.

Aspect 58: A non-transitory computer-readable medium storing a set of instructions for wireless communication, the set of instructions comprising one or more instructions that, when executed by one or more processors of a device, cause the device to perform the method of one or more of Aspects 23-27.

Aspect 59: A device for wireless communication, the device comprising a processing system that includes one or more processors and one or more memories coupled with the one or more processors, the processing system configured to cause the device to perform the method of one or more of Aspects 23-27.

Aspect 60: An apparatus for wireless communication at a device, the apparatus comprising one or more memories and one or more processors coupled to the one or more memories, the one or more processors individually or collectively configured to cause the device to perform the method of one or more of Aspects 23-27.

Aspect 61: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 28-39.

Aspect 62: An apparatus for wireless communication at a device, the apparatus comprising one or more memories and one or more processors coupled to the one or more memories, the one or more processors configured to cause the device to perform the method of one or more of Aspects 28-39.

Aspect 63: An apparatus for wireless communication, the apparatus comprising at least one means for performing the method of one or more of Aspects 28-39.

Aspect 64: A non-transitory computer-readable medium storing code for wireless communication, the code comprising instructions executable by one or more processors to perform the method of one or more of Aspects 28-39.

Aspect 65: A non-transitory computer-readable medium storing a set of instructions for wireless communication, the set of instructions comprising one or more instructions that, when executed by one or more processors of a device, cause the device to perform the method of one or more of Aspects 28-39.

Aspect 66: A device for wireless communication, the device comprising a processing system that includes one or more processors and one or more memories coupled with the one or more processors, the processing system configured to cause the device to perform the method of one or more of Aspects 28-39.

Aspect 67: An apparatus for wireless communication at a device, the apparatus comprising one or more memories and one or more processors coupled to the one or more memories, the one or more processors individually or collectively configured to cause the device to perform the method of one or more of Aspects 28-39.

Aspect 68: A method, device, apparatus, computer program product, non-transitory computer-readable medium, user equipment, base station, network node, wireless node, wireless communication device, and/or processing system as substantially described herein with reference to and as illustrated by accompanying drawings and specification.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
prioritize, based at least in part on multiple synchronization raster types, two or more synchronization rasters according to their respective synchronization raster types included in the multiple synchronization raster types to select a highest priority synchronization raster in the two or more synchronization rasters; and
search for a synchronization signal based at least in part on the highest priority synchronization raster.

2. The UE of claim 1, wherein the multiple synchronization raster types include at least:
a primary synchronization raster type, and
a secondary synchronization raster type.

3. The UE of claim 2, wherein the primary synchronization raster type is associated with a first scaling factor, and
wherein the secondary synchronization raster type is associated with a second scaling factor that is different from the first scaling factor.

4. The UE of claim 1, wherein the highest priority synchronization raster is a first synchronization raster, and
wherein the processing system is configured to:
detect the synchronization signal based at least in part on the first synchronization raster; and
obtain, using at least the synchronization signal, assistance information that is associated with locating a second synchronization raster.

5. The UE of claim 1, wherein the processing system is configured to cause the UE to:
fail to detect the synchronization signal using the highest priority synchronization raster; and
search for the synchronization signal using a second highest priority synchronization raster in the two or more synchronization rasters.

6. The UE of claim 5, wherein the second highest priority synchronization raster is associated with locating assistance information associated with one or more additional synchronization rasters.

7. The UE of claim 1, wherein the processing system is configured to cause the UE to:
receive an indication of one or more synchronization raster properties, the one or more synchronization raster properties including at least one of:
a presence property,
a time duration property, or
a validity area property.

8. The UE of claim 7, wherein the one or more synchronization raster properties include one or more band-specific synchronization raster properties.

9. A method of wireless communication performed by a user equipment (UE), comprising:
prioritizing, based at least in part on multiple synchronization raster types, two or more synchronization rasters according to their respective synchronization raster types included in the multiple synchronization raster types to select a highest priority synchronization raster in the two or more synchronization rasters; and
searching for a synchronization signal based at least in part on the highest priority synchronization raster.

10. The method of claim 9, wherein the multiple synchronization raster types include at least:
a primary synchronization raster type, and
a secondary synchronization raster type.

11. The method of claim 10, wherein the primary synchronization raster type is associated with a first scaling factor, and
wherein the secondary synchronization raster type is associated with a second scaling factor that is different from the first scaling factor.

12. The method of claim 9, wherein the highest priority synchronization raster is a first synchronization raster, and
wherein the method further comprises:
detecting the synchronization signal based at least in part on the first synchronization raster; and
obtaining, using at least the synchronization signal, assistance information that is associated with locating a second synchronization raster.

13. The method of claim 9, further comprising:
failing to detect the synchronization signal using the highest priority synchronization raster; and
searching for the synchronization signal using a second highest priority synchronization raster in the two or more synchronization rasters.

14. The method of claim 13, wherein the second highest priority synchronization raster is associated with locating assistance information associated with one or more additional synchronization rasters.

15. The method of claim 9, further comprising:
receiving an indication of one or more synchronization raster properties, the one or more synchronization raster properties including at least one of:
a presence property,
a time duration property, or
a validity area property.

16. The method of claim 15, wherein the one or more synchronization raster properties include one or more band-specific synchronization raster properties.

17. A non-transitory computer-readable medium storing a set of instructions for wireless communication, the set of instructions comprising:
one or more instructions that, when executed by one or more processors of a user equipment (UE), cause the UE to:
prioritize, based at least in part on multiple synchronization raster types, two or more synchronization rasters according to their respective synchronization raster types included in the multiple synchronization raster types to select a highest priority synchronization raster in the two or more synchronization rasters; and
search for a synchronization signal based at least in part on the highest priority synchronization raster.

18. The non-transitory computer-readable medium of claim 17, wherein the multiple synchronization raster types include at least:
a primary synchronization raster type, and
a secondary synchronization raster type.

19. The non-transitory computer-readable medium of claim 18, wherein the primary synchronization raster type is associated with a first scaling factor, and
wherein the secondary synchronization raster type is associated with a second scaling factor that is different from the first scaling factor.

20. The non-transitory computer-readable medium of claim 17, wherein the highest priority synchronization raster is a first synchronization raster, and
wherein the one or more instructions further cause the UE to:
detect the synchronization signal based at least in part on the first synchronization raster; and
obtain, using at least the synchronization signal, assistance information that is associated with locating a second synchronization raster.
